(19) United States
(12) Patent Application Publication
(10) Pub. No.: US 2016/0340556 A1
(43) Pub. Date: Nov. 24, 2016

(54) ADHESIVE SHEET, REINFORCING REPAIR TAPE, AND REINFORCED BUILDING MATERIAL

(71) Applicant: 3M INNOVATIVE PROPERTIES COMPANY, Saint Paul,, MN (US)

(72) Inventor: Norihisa Watanabe, Tokyo (JP)

(21) Appl. No.: 15/038,055

(22) PCT Filed: Dec. 1, 2014
(86) PCT No.: PCT/US2014/067910

§ 371 Date: May 20, 2016

(30) Foreign Application Priority Data
Dec. 2, 2013 (JP) 2013-249364

(51) Int. Cl. C09J 7/04; E04G 23/02; E04C 5/07

(52) U.S. Cl. CPC C09J 7/048; C09J 7/045; C09J 7/043; E04C 5/07; E04G 23/0218; C09J 2433/00; C09J 2477/00; E04G 2023/0251

(57) ABSTRACT

The present invention is to provide an adhesive sheet having superior workability and instantly exhibiting stable, high-level reinforcing/repairing performance when bonded to an adherend such as a building material. An adhesive sheet according to the present invention comprises a substrate layer comprising reinforcing fibers impregnated with an acidic resin and a basic adhesive layer disposed upon the substrate layer.

### FIELD OF THE INVENTION

The present disclosure relates to an adhesive sheet capable of being used to reinforce and repair an adherend. More specifically, the present disclosure relates to an adhesive sheet and a reinforcing repair tape suitable for reinforcing and repairing a building material, and to a building material reinforced using the reinforcing repair tape.

### BACKGROUND ART

Reinforcing fiber sheets of carbon fibers or the like are generally bonded to structural materials, such as concrete used as a building material or sheet steel used for automobile exteriors, in order to reinforce or repair the same.

One method of reinforcing concrete building materials, such as concrete pillars, is to wrap them in fiber-reinforced plastic (FRP). Such methods of wrapping in FRP require numerous work steps, such as treating the substrate by grinding away degraded parts of the concrete surface, applying an epoxy adhesive primer, fixing irregularities in the surface of the concrete, applying a base coat of epoxy adhesive, wrapping FRP sheets containing reinforcing fibers such as carbon fibers or aramid fibers, applying a top coat of epoxy adhesive so as to impregnate the FRP sheet, and curing. The epoxy adhesive preferably has a long working time so as to allow the builder to adjust the bonding position after the FRP sheet has been wrapped around the concrete pillar. Thus, the time needed to wrap and cure one FRP sheet is generally at least one day, and a working period of at least two days is necessary if a plurality of FRP sheets are wrapped.

Japanese Unexamined Patent Application Publication No. H08-218646A discloses a “method of reinforcing a concrete structure by removing and repairing damaged sections in and cleaning the surface of a pillar-shaped concrete structure, followed by applying a primer to the surface and curing, evenly applying an adhesive to the surface, then wrapping and bonding a concrete structure-reinforcing tape around the pillar-shaped concrete structure without any slack, chemical fibers of good softness and a tensile strength greater than that of concrete being used for the lengthwise fibers of the tape and chemical fibers capable of fixing the position of the lengthwise fibers being used for the widthwise fibers, the lengthwise chemical fibers being interwoven with the widthwise fibers in a linearly arranged state, and a fiber space for actively forcing the adhesive to flow being woven between the front and back sides of the tape”.

Japanese Unexamined Patent Application Publication No. H10-259665A discloses a “method of reinforcing a building in which a release sheet of a high-strength fiber reinforcing sheet having a releasable adhesive applied to an entire rear surface thereof and a release sheet layered thereupon is peeled off, the rear surface of the reinforcing sheet is compressed and releasably bonded to the surface of a building, the releasably bonded high-strength fiber reinforcing sheet is then thoroughly impregnated with adhesive, and, finally, the surface of the impregnated high-strength fiber reinforcing sheet is finished”.

Japanese Unexamined Patent Application Publication No. H10-311145A discloses a “reinforcing fiber sheet for a concrete structure in which a primary sheet is releasably semi-bonded to a backing paper via an adhesive, wherein the backing paper is transparent or semi-transparent”.

Japanese Unexamined Patent Application Publication No. H11-062259A discloses a “reinforcing repair adhesive tape in which a reinforcing fiber sheet drawn into alignment in a single direction comprises a base cloth of rough woven fabric on at least one side thereof, and one surface of the sheet comprises a layer of adhesive”.

Japanese Unexamined Patent Application Publication No. 2002-047809A discloses a “reinforced composite material obtained by first bonding a curable fiber-reinforced plastic (“pre-preg”) sheet comprising a layer of pressure-sensitive adhesive on one or both surfaces to a predetermined carrier using the layer of pressure-sensitive adhesive, followed by curing the pre-preg using an appropriate method; as well as a method of manufacturing and a method of applying the same”.

Japanese Unexamined Patent Application Publication No. H11-124955A discloses a “method of reinforcing a concrete pillar in which a belt-shaped reinforcing member of reinforcing fibers, such as aromatic polyamide fibers, is wrapped around a concrete pillar, such as a bridge pier, provided near a wall surface, and the reinforcing fibers are impregnated with resin to reinforce the concrete pillar; wherein a cured section impregnated with resin and cured in advance is formed in a central part of the lengthwise direction of the belt-shaped reinforcing member, an adhesive is applied to one surface of the cured section, after which the reinforcing member is wrapped around so that the cured section is positioned on a side surface of the concrete pillar facing the wall and the cured section is applied to the side surface, the parts of the reinforcing member other than the cured section are impregnated with resin and applied to the pillar, and the resin is cured”.

Japanese Unexamined Patent Application Publication No. H11-050348A discloses a “reinforcing tape constituted by a reinforcing sheet constituted by an elongated fiber sheet, marks being formed at constant intervals in the lengthwise direction”.

### SUMMARY OF THE INVENTION

Because the FRP wrap method involves multiple onsite work steps, as described above, it is labor-intensive and takes time to apply. In addition, in order to yield design strength, uniform tension must be applied to the FRP sheet when being wrapped, and the quality of the finished product is highly dependent upon the worker. Moreover, when reinforcing or repairing railroad bridge piers, concrete pillars for buildings housing restaurants or other shops, or the like, work time is often limited to late at night, when the trains have stopped running or the shops are closed. In addition, because the FRP wrap method is a wet method, it may exhibit problems such as uneven curing due to vibrations from passing trains if a railroad bridge pier is reinforced or repaired, or unpleasant odors from the epoxy adhesive if construction is performed near a shop.

The present disclosure provides an adhesive sheet having superior workability and instantly exhibiting stable, high-level reinforcing/repairing performance when bonded to an adherend such as a building material.

### Means to Solve the Problem

In accordance with one embodiment of the present disclosure, an adhesive sheet is provided comprising a substrate layer comprising reinforcing fibers impregnated with an acidic resin and a basic adhesive layer disposed upon the substrate layer.

In accordance with another embodiment of the present disclosure, a reinforcing repair tape and a building material-reinforcing repair tape comprising the adhesive sheet are provided.

In accordance with yet another embodiment of the present disclosure, a reinforced building material around which the building material-reinforcing repair tape is wrapped is provided.

### Effect of the Invention

In the adhesive sheet according to the present disclosure, the reinforcing fiber-containing substrate layer and the adhesive layer are integrally formed, yielding superior workability, and allowing design strength to be obtained immediately after application.

In addition, the adhesive sheet according to the present disclosure is provided with a substrate layer in which the reinforcing fibers are pre-impregnated with an acidic resin to form an integrated whole, allowing for the suppression of shifting that occurs between the reinforcing fibers and the acidic resin when stress is applied to the adhesive sheet. Moreover, the acid-base interaction between the acidic resin-containing substrate layer and the basic adhesive layer at the interface of the two layers allows the two to strongly bond to each other. The synergistic effects of these various features allows the adhesive sheet according to the present disclosure to exhibit a high level of shear strength in a direction parallel with the surface of the adhesive sheet.

The above descriptions should not be construed to be a disclosure of all of the embodiments and benefits of the present invention.

### BRIEF DESCRIPTION OF THE DRAWINGS

FIG. 1 is a cross-sectional view of an adhesive sheet according to one embodiment of the present disclosure.

FIG. 2 is a perspective view of a concrete pillar reinforced by wrapping a reinforcing repair tape according to one embodiment of the present disclosure.

FIG. 3 is a cross-sectional view of a concrete pillar with a reinforcing repair tape according to one embodiment of the present disclosure wrapped twice therearound.

FIG. 4 is a magnified view of the portion indicated by dotted lines in FIG. 3.

FIG. 5 is a chart illustrating a lining test (compression test) for a first example and a first comparative example.

### DETAILED DESCRIPTION OF THE INVENTION

A detailed description for the purpose of illustrating representative embodiments of the present invention is given below, but these embodiments should not be construed as limiting the present invention.

In the present disclosure, “(meth)acrylic” refers to “acrylic or methacrylic”, and “(meth)acrylate” refers to “acrylate or methacrylate”.

An adhesive sheet according to one embodiment of the present disclosure comprises a substrate layer comprising reinforcing fibers impregnated with an acidic resin and a basic adhesive layer disposed upon the substrate layer.

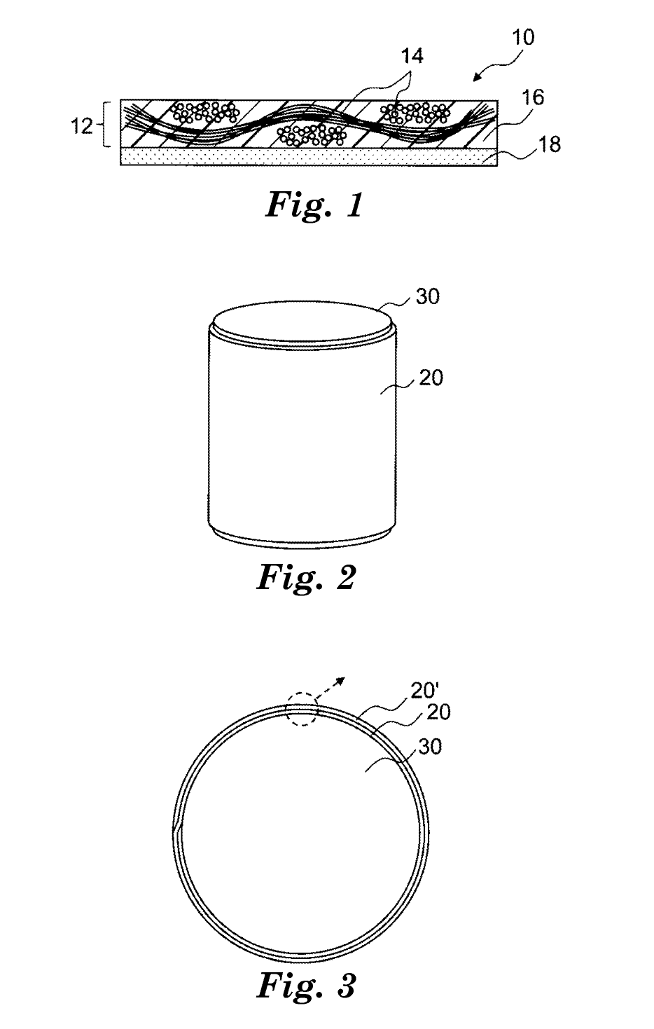

A cross-sectional view of an adhesive sheet according to an embodiment of the present disclosure is illustrated in FIG. 1. An adhesive sheet 10 comprises a substrate layer 12 and a layer of basic adhesive 18 disposed thereupon. The substrate layer 12 comprises reinforcing fibers 14, and the reinforcing fibers 14 are impregnated with an acidic resin 16.

The reinforcing fibers serve as a scaffold for the substrate layer, and are a primary element in determining the strength of the adhesive sheet. Carbon fibers, glass fibers, and other inorganic continuous fibers, aromatic polyamide fibers (aramid fibers), nylon fibers, vinylon fibers, polyester fibers, polyparaphenylene benzoxazole (PBO) fibers, high-strength polyethylene fibers, and other organic continuous fibers, and combinations thereof can be used as the reinforcing fibers. Carbon fibers and aramid fibers are advantageously used due to their high strength, and carbon fibers are especially advantageous due to their light weight.

The reinforcing fibers may be drawn and aligned in one direction, or may be woven or knitted into a plain weave, twill, heavy twill, satin, or other type of sheet. Both the warp and the filling fibers may be constituted by reinforcing fibers, or another type of fiber may be used for one. Plain weave or twill sheets are generally used, as they are easily obtainable. The width of the reinforcing fiber sheet may vary according to application; for instance, if the sheet is used to reinforce or repair a concrete building material, the width of the sheet is generally about 200 mm or greater, about 250 mm or greater, or about 300 mm or greater and about 1,500 mm or less, about 1,000 mm or less, or about 800 mm or less out of considerations of workability, efficiency, and the like.

The mass (also referred to as “fabric weight” or “basis weight”) of the reinforcing fiber sheet is generally about 50 g/m² or more, about 100 g/m² or more, or about 150 g/m² or more, and about 1,000 g/m² or less, about 800 g/m² or less, or about 500 g/m² or less. The thickness of the reinforcing fiber sheet can be selected out of consideration for the required reinforcing/repairing strength and workability, and is generally about 0.05 mm or more, about 0.1 mm or more, or about 0.15 mm or more, and about 1 mm or less, about 0.8 mm or less, or about 0.5 mm or less.

The fiber diameter of the reinforcing fibers is generally about 0.05 mm or more, about 0.08 mm or more, or about 0.10 mm or more, and about 1.20 mm or less, about 0.70 mm or less, or about 0.35 mm. The tensile strength of the reinforcing fibers is selected according to application, and will generally be about 0.01 kN/mm² or more, about 0.1 kN/mm² or more, or about 1.0 kN/mm² or more, and about 100 kN/mm² or less, about 50 kN/mm² or less, or about 20 kN/mm² or less as measured according to JIS A 1191:2004, “Test method for tensile properties of fiber reinforced polymer (FRP) sheets for reinforcement of concrete”. The breaking elongation of the reinforcing fibers is generally about 0% or more, about 0.2% or more, or about 0.5% or more and about 10% or less, about 8% or less, or about 6% or less as measured according to JIS A 1191:2004, “Test method for tensile properties of fiber reinforced polymer (FRP) sheets for reinforcement of concrete”. Generally, reinforcing fibers used for reinforcing purposes are required to resist elongation and have high tensile strength; thus, carbon fibers, aramid fibers, or a combination thereof is preferable.

The acidic resin impregnates the reinforcing fibers to form a matrix for the substrate layer, and is an element imparting additional strength to the adhesive sheet. In the present disclosure, “acidic” refers to the material having sites having the property of accepting electron pairs as an electron pair acceptor (i.e., being a Lewis acid), or having sites having the property of forming a conjugate acid with added hydrogen ions. In the present disclosure, “basic” refers to the substance having sites having the property of donating electron pairs as an electron pair donor (i.e., being a Lewis base), or having sites having the property of forming a conjugate base with detached hydrogen ions. In the present disclosure, “acidic” and “basic” are relative concepts dependent upon the material constituting the object of comparison. For example, a material having both sites functioning as a Lewis acid and sites functioning as a Lewis base will function as a basic material if another material adjacent to the material is acidic, and will function as an acidic material if another material adjacent to the material is basic; thus, it can be applied, as appropriate, to either the acidic resin or the basic adhesive to be described hereafter.

Various polymer materials comprising active hydrogen-containing functional groups, such as carboxyl groups, hydroxyl groups, sulfonic acid groups, sulfuric acid groups, phosphonic acid groups, phosphoric acid groups, or the like, can be used as the acidic resin. A polymer material comprising a functional group that, while not containing active hydrogen, serves to impart the material with acidity as defined above, such as a carboxylate group, can also be used as the acidic resin.

The acidic resin may be any of a thermoplastic resin, a thermoset resin, or a radiation-curing resin. Examples of the acceptable polymer material used as acidic resins include (meth)acrylic resin, epoxy resin, polyester, polyurethane, polypropylene, ethylene-vinyl acetate copolymer, polyvinyl chloride, polyvinylidene chloride, silicone resin, and the like. If the adhesive sheet is applied to a curved surface, the acidic resin is advantageously an elastomer having visco-elastic properties. If the acidic resin is an elastomer, the reinforcing effects of the adhesive sheet can suppress rapid degradation arising from brittle failure of the acidic resin.

The glass transition temperature (Tg) of the acidic resin is generally about −60° C. or higher, about −40° C. or higher, or about 0° C. or higher, and about 200° C. or lower, about 100° C. or lower, or about 50° C. or lower. The Tg is determined via differential scanning calorimetry (DSC). The strength and rigidity of the adhesive sheet will increase, improving reinforcing/repairing performance, as the Tg increases, but softness will decrease, potentially reducing stress relaxation properties, conformity to curved surfaces, workability, and the like.

A favorable example of an acidic resin is acidic (meth)acrylic resin. (Meth)acrylic resin can be obtained by polymerizing an alkyl (meth)acrylate monomer having from 1 to 30 carbons at the ester site, as well as an active hydrogen-containing acidic monomer and/or a crosslinking agent-containing mixture as necessary. Polymerization can be performed via thermal polymerization or photopolymerization. Examples of possible initiators include thermal polymerization initiators known in the art, such as benzoyl peroxide and azobis isobutyronitrile (AIBN), or photoinitiators, such as benzophenone and 2,2-dimethoxy-2-phenyl acetophenone.

Examples of alkyl (meth)acrylate monomers having from 1 to 30 carbons at the ester site include methyl (meth)acrylate, ethyl (meth)acrylate, n-butyl (meth)acrylate, isoamyl (meth)acrylate, n-hexyl (meth)acrylate, 2-ethylhexyl (meth)acrylate, isooctyl (meth)acrylate, isononyl (meth)acrylate, decyl (meth)acrylate, dodecyl (meth)acrylate, and other alkyl (meth)acrylates; phenyl (meth)acrylate; methoxypropyl (meth)acrylate, 2-methoxybutyl (meth)acrylate, and other alkoxyalkyl (meth)acrylates; and phenoxyethyl (meth)acrylate and other phenoxyalkyl (meth)acrylates. One or more types of these can be used in order to obtain the desired glass transition temperature, tensile strength, elongation properties, and the like. Alkyl ester groups derived from these monomers exhibit acidity.

Examples of active hydrogen-containing acidic monomers include (meth)acrylic acid, maleic acid, itaconic acid, ω-carboxy polycaprolactone monoacrylate, phthalic acid mono hydroxyethyl (meth)acrylate, ω-carboxyethyl acrylate, 2-(meth)acryloyl oxyethyl succinic acid, 2-(meth)acryloyl oxyethyl hexahydrophthalic acid, hydroxyethyl (meth)acrylate, hydroxypropyl (meth)acrylate, and other hydroxyalkyl (meth)acrylates, vinyl sulfonic acid, 4-styrene sulfonic acid, and the like. Carboxyl groups, hydroxyl groups, sulfonic acid groups, and the like form hydrogen bonds that further strengthen the bond between the substrate layer and the basic adhesive layer; thus, it is advantageous to copolymerize these monomers.

Examples of crosslinking agents include difunctional or multifunctional (meth)acrylates, such as 1,4-butanediol di(meth)acrylate, 1,6-hexanediol di(meth)acrylate, ethylene glycol di(meth)acrylate, cyclohexane dimethanol di(meth)acrylate, diethylene glycol di(meth)acrylate, dipropylene glycol di(meth)acrylate, polyethylene glycol di(meth)acrylate, and other difunctional (meth)acrylates; and glycerol tri(meth)acrylate, trimethylol propane tri(meth)acrylate, pentaerythritol tri(meth)acrylate, ditrimethylolpropane tetra(meth)acrylate, dipentaerythritol penta(meth)acrylate, pentaerythritol tetra(meth)acrylate, and other multifunctional (meth)acrylates. Polymerizable oligomers such as urethane acrylate, polyester acrylate, and epoxy acrylate can also be used as crosslinking agents. The use of a crosslinking agent increases the strength of the adhesive sheet while simultaneously allowing alkyl (meth)acrylate monomers having low homopolymer Tg when polymerized in isolation, such as ethyl acrylate, n-butyl acrylate, 2-ethylhexyl acrylate, and other alkyl acrylate monomers, to be used to adjust the Tg of the acidic resin to within a desired range.

If an active hydrogen-containing acidic monomer and/or a crosslinking agent is copolymerized, a (meth)acrylic resin can be obtained by copolymerizing, for example, about 50 parts by mass or more, about 55 parts by mass or more, or about 60 parts by mass or more and about 100 parts by mass or less, about 95 parts by mass or less, or about 90 parts by mass or less of an alkyl (meth)acrylate monomer having from 1 to 30 carbons at the ester site; about 2 parts by mass or more, about 5 parts by mass or more, or about 10 parts by mass or more and about 40 parts by mass or less, about 35 parts by mass or less, or about 30 parts by mass or less of an active hydrogen-containing acidic monomer; and about 0.01 parts by mass or more, about 0.02 parts by mass or more, or about 0.05 parts by mass or more and about 5 parts by mass or less, about 3 parts by mass or less, or about 2 parts by mass or less of a crosslinking agent.

The reinforcing fibers can be impregnated with the acidic (meth) acrylic resin by calender-molding. The acidic (meth) acrylic monomer can be converted into a polymerizable oligomer by partially polymerizing (pre-polymerizing) it in advance and this partial polymerization is preferably performed until the viscosity becomes approximately from 5 to 10,000 mPa−s. Instead of using the pre-polymerized acid (meth) acrylic resin, acidic (meth) acrylic monomers with polymerization initiator can be used to impregnate the reinforcing fibers.

The acidic resin may optionally have adhesive properties. For example, if the acidic resin is a pressure-sensitive adhesive or a hot-melt adhesive, an adhesive sheet can be disposed between two adherends to bond the adherends. It is also possible to bond the substrate layer to an adherend, and apply another layer or film, such as a decorative film, to the basic adhesive layer.

The mass ratio of the acidic resin and reinforcing fibers in the substrate layer is generally about 5 parts by mass or more, about 10 parts by mass or more, or about 20 parts by mass or more and about 1,500 parts by mass or less, about 1,300 parts by mass or less, or about 1,000 parts by mass or less acidic resin per 100 parts by mass reinforcing fibers.

The thickness of the substrate layer is broadly determined by the thickness of the reinforcing fibers, and will generally be about 0.05 mm or more, about 0.1 mm or more, or about 0.15 mm or more, and about 1 mm or less, about 0.8 mm or less, or about 0.5 mm or less.

In addition to the acidic resin and the reinforcing fibers, the substrate layer may further comprise a filler, an antioxidant, a UV absorber, or another optional ingredient.

The basic adhesive layer is disposed upon the substrate layer. Various materials comprising nitrogen atom-containing functional groups, such as amino groups, amide groups, imino groups, nitrile groups, and the like, can be used as the basic adhesive. The basic adhesive may be a pressure-sensitive adhesive or a hot-melt adhesive. If a pressure-sensitive adhesive is used, the adhesive sheet can be bonded to the adherend at normal temperatures, allowing the ease of application of the adhesive sheet to be improved. If a hot-melt adhesive is used, the adhesive sheet will generally be applied to an adherend while being heated to about 100° C. or higher, about 120° C. or higher, or about 150° C. or higher and about 200° C. or less, about 180° C. or less, or about 170° C. or less, after which the adhesive sheet is cooled and bonded to the adherend.

Examples of basic adhesives include basic (meth)acrylic adhesives, basic epoxy adhesives, basic phenolic resin adhesives, basic urethane adhesives, polyamide adhesives, nitrile rubber adhesives, and the like.

A basic (meth)acrylic adhesive, which is one type of favorable basic adhesive, can be obtained by polymerizing a mixture comprising an alkyl (meth)acrylate monomer having from 4 to 30 carbons at the ester site, a basic monomer, and a crosslinking agent, and is generally a pressure-sensitive adhesive. Polymerization can be performed via thermal polymerization or photopolymerization. Examples of possible initiators include thermal polymerization initiators known in the art, such as benzoyl peroxide and azobis isobutyronitrile (AIBN), or photoinitiators, such as benzophenone and 2,2-dimethoxy-2-phenyl acetophenone.

Examples of alkyl (meth)acrylate monomers having from 4 to 30 carbons at the ester site include n-butyl (meth)acrylate, isoamyl (meth)acrylate, n-hexyl (meth)acrylate, 2-ethylhexyl (meth)acrylate, isooctyl (meth)acrylate, isononyl (meth)acrylate, decyl (meth)acrylate, dodecyl (meth)acrylate, and other alkyl (meth)acrylates; phenyl (meth)acrylate; methoxypropyl (meth)acrylate, 2-methoxybutyl (meth)acrylate, and other alkoxyalkyl (meth)acrylates; and phenoxyethyl (meth)acrylate and other phenoxyalkyl (meth)acrylates. One or more types of these can be used in order to obtain the desired adhesive properties.

A compound comprising an ethylenic unsaturated group and a nitrogenous group selected from the group consisting of an amino group, an amide group, an imino group, a nitrile group, an imide group, and combinations thereof can be used as the basic monomer. Examples of basic monomers include 2-amino (meth)acrylate, N,N-dimethyl aminoethyl (meth)acrylate, 2-diethyl aminoethyl (meth)acrylate, 1-(methylamino)ethyl (meth)acrylate, 2-(methylamino)ethyl (meth)acrylate, 1-(ethylamino)ethyl (meth)acrylate, 2-(ethylamino)ethyl (meth)acrylate, 3-(dimethylamino)propyl (meth)acrylate, N-tert-butyl aminoethyl (meth)acrylate, (meth)acrylamide, dimethyl (meth)acrylamide, diethyl (meth)acrylamide, N-[3-(dimethyl amino)propyl] (meth)acrylamide, 2-vinyl pyridine, 4-vinyl pyridine, dimethyl allylamine, diallyl methylamine and other compounds comprising an amino group or an amide group; 3-hydroxy-4-(phenyl iminomethyl) phenyl (meth)acrylate, 4-[[(4-ethyl phenyl) imino] methyl] phenyl (meth)acrylate, 4-[(4-ethoxyphenyl) iminomethyl] phenyl (meth)acrylate, 4-[[(4-butylphenyl)imino]methyl] phenyl (meth)acrylate, 3-hydroxy-4-[1-(phenylimino)ethyl] phenyl (meth)acrylate, and other compounds comprising an imino group; 4-(4′-cyano-4-biphenylyl oxy) butyl (meth)acrylate, 6-(4′-cyano-4-biphenylyl oxy) hexyl (meth)acrylate, 2-[ethyl[4-(1,2,2-tricyano ethenyl) phenyl] amino] ethyl (meth)acrylate, 8-(4′-cyanoazobenzen-4-yl oxy) octyl (meth)acrylate, and other compounds comprising a nitrile group; and N-vinyl succinimide, N-vinyl maleinimide, N-vinyl phthalimide, N-(4-vinyl phenyl) maleinimide, N-[2-(vinyloxy) ethyl] phthalimide, N-(4-vinyl phenyl) phthalimide, and other compounds comprising an imide group. N-methyl diethanolamine di(meth)acrylate, N-ethyl diethanolamine di(meth)acrylate, [(isopropyl imino) bis(2,1-ethane diyl)] di(meth)acrylate, [(tert-butylimino) bis(2,1-ethane diyl)] di(meth)acrylate, and other nitrogenous multifunctional (meth)acrylates can also be used; these also function as crosslinking agents. Because highly basic nitrogenous groups increase the strength of the bond with the acidic substrate layer, it is advantageous to copolymerize a monomer comprising a highly basic nitrogenous group, such as an amino group, an imino group, or the like.

Examples of crosslinking agents include difunctional or multifunctional (meth)acrylates, such as 1,4-butanediol di(meth)acrylate, 1,6-hexanediol di(meth)acrylate, ethylene glycol di(meth)acrylate, cyclohexane dimethanol di(meth)acrylate, diethylene glycol di(meth)acrylate, dipropylene glycol di(meth)acrylate, polyethylene glycol di(meth)acrylate, and other difunctional (meth)acrylates; and glycerol tri(meth)acrylate, trimethylol propane tri(meth)acrylate, pentaerythritol tri(meth)acrylate, ditrimethylolpropane tetra(meth)acrylate, dipentaerythritol penta(meth)acrylate, pentaerythritol tetra(meth)acrylate, and other multifunctional (meth)acrylates. Polymerizable oligomers such as urethane acrylate, polyester acrylate, and epoxy acrylate can also be used as crosslinking agents.

A basic (meth)acrylic adhesive can be obtained by copolymerizing, for example, about 50 parts by mass or more, about 55 parts by mass or more, or about 60 parts by mass or more and about 100 parts by weight or less, about 95 parts by mass or less, or about 90 parts by mass or less of an alkyl (meth)acrylate monomer having from 4 to 30 carbons at the ester site; about 2 parts by mass or more, about 5 parts by mass or more, or about 10 parts by mass or more and about 40 parts by mass or less, about 35 parts by mass or less, or about 30 parts by mass or less of a basic monomer; and about 0.01 parts by mass or more, about 0.02 parts by mass or more, or about 0.05 parts by mass or more and about 5 parts by mass or less, about 3 parts by mass or less, or about 2 parts by mass or less of a crosslinking agent.

A polyamide adhesive, which is another favorable basic adhesive, comprises a polyamide obtainable via polycondensation of a polyamine with a dibasic acid such as a dimer acid, polycondensation of an aminocarboxylic acid, ring-opening polymerization of a lactam, or the like. Because polyamides are thermoplastic, polyamide adhesives are generally hot-melt adhesives.

The melt viscosity of a hot-melt polyamide adhesive at 160° C. is generally about 2,000 mPa·s or higher or about 2,500 mPa·s or higher, and about 6,000 mPa·s or lower or about 5,500 mPa·s or lower. The resin softening point of a hot-melt polyamide adhesive is generally about 80° C. or higher, about 100° C. or higher, or about 110° C. or higher, and about 150° C. or lower, about 145° C. or lower, or about 135° C. or lower.

Tackifiers such as rosin, rosin ester, rosin phenol, terpene phenol and so on or plasticizer such as amide compound including N-ethyl aminosulfonic acid amide and so on or ester compound including dibutyl sebacate, dioctyl phthalate and so on, can be further added to the polyamide adhesive. Adding a tackifier to the polyamide adhesive increases the glass transition temperature (Tg) of the polyamide adhesive, and also allows a solvent-type adhesive sheet to be obtained.

The thickness of the basic adhesive layer is generally about 0.01 mm or more, about 0.015 mm or more, or about 0.02 mm or more, and about 0.2 mm or less, about 0.15 mm or less, or about 0.1 mm or less.

V-shaped, U-shaped, or other grooves may be disposed on the surface of the basic adhesive layer in a desired pattern, facilitating ventilation when the adhesive sheet is applied to an adherend. A liner release-treated with silicone or the like may be disposed upon the basic adhesive layer. The grooves in the surface of the basic adhesive layer may also be formed by furrows having V- or U-shaped or other grooved cross sections provided in the surface of the release liner.

The adhesive sheet can be prepared by forming a substrate layer of reinforcing fibers impregnated with an acidic resin, and layering a basic adhesive layer thereupon.

If the acidic resin is a thermoplastic resin, the substrate layer can be formed by heating and melting the acidic resin, impregnating the reinforcing fibers with the melted resin, and cooling. Impregnation can be performed via immersion, coating, spraying, or the like, immersion being preferable as it facilitates uniform impregnation. It is also possible to impregnate the reinforcing fibers with a solution of the acidic resin in acetone, methyl ethyl ketone, cyclohexanone, methyl isobutyl ketone, cyclopentanone, dimethyl formamide, dimethyl acetamide, N-methyl pyrrolidone, or another solvent, and then remove the solvent to form the substrate layer. If the acidic resin is a thermoset resin or a UV-curing resin, the reinforcing fibers can be impregnated with a polymerizable mixture containing a monomer making up the acidic resin and a thermal polymerization initiator or photopolymerization initiator, and then heated or irradiated with radiation such as UV radiation or an electron beam, thereby curing the polymerizable mixture and forming the substrate layer. It is also possible to prepare a polymerizable acrylic resin composition in which all or part of the monomer making up the acidic resin is pre-polymerized, impregnate the reinforcing fibers with a polymerizable mixture of a monomer, crosslinking agent, thermal polymerization initiator, photopolymerization initiator, or the like added to the polymerizable acrylic resin composition as necessary, and then heat or irradiate the fibers with radiation such as UV radiation or an electron beam to cure the polymerizable mixture and form the substrate layer. The pre-polymerization can be performed via either of thermal polymerization or photopolymerization, and usable initiators are as described above.

If the basic adhesive layer comprises, for example, a (meth)acrylic adhesive, the polymerizable mixture comprising the monomer making up the adhesive and the thermal polymerization initiator or photoinitiator can be heated or irradiated with radiation such as UV radiation or an electron beam to cure, thereby forming a basic adhesive layer. It is also possible to prepare a polymerizable acrylic resin composition in which all or part of the monomer making up the adhesive is pre-polymerized, and then heat or irradiate a polymerizable mixture of a monomer, crosslinking agent, thermal polymerization initiator, photopolymerization initiator, or the like added to the polymerizable acrylic resin composition as necessary with radiation such as UV radiation or an electron beam to cure the polymerizable mixture and form the basic adhesive. The pre-polymerization can be performed via either of thermal polymerization or photopolymerization, and usable initiators are as described above. If the basic adhesive layer comprises a hot-melt adhesive such as a polyamide adhesive, the hot-melt adhesive can be heated, melted, and molded into a sheet to form the basic adhesive layer. The basic adhesive layer can also be formed by impregnating the reinforcing fibers with a solution of basic adhesive, and then removing the solvent.

The adhesive sheet may further comprise an addition layer, such as a decorative layer or a gas barrier layer.

The adhesive sheet can be applied to a flat or curved surface of an adherend, such as a floor slab, to reinforce or repair the adherend or prevent crumbling of part of the adherend. In accordance with an embodiment of the present disclosure, a reinforcing repair tape comprising an adhesive sheet is provided. Putting the adhesive sheet into the form of a reinforcing repair tape allows for easy application to a three-dimensional adherend, such as lining a cylindrical or prism-shaped adherend.

In an embodiment of the present disclosure, the reinforcing repair tape is used as a building material-reinforcing repair tape. Examples of building materials to which the reinforcing repair tape can be applied include bridge piers, concrete pillars of buildings or the like, smokestacks, slabs, and the like. The lengthwise direction of the reinforcing repair tape is aligned with the circumferential direction of the adherend, and can be wrapped one or more times around the circumference of the building material. The tape shape allows tension to be applied as the tape is wrapped.

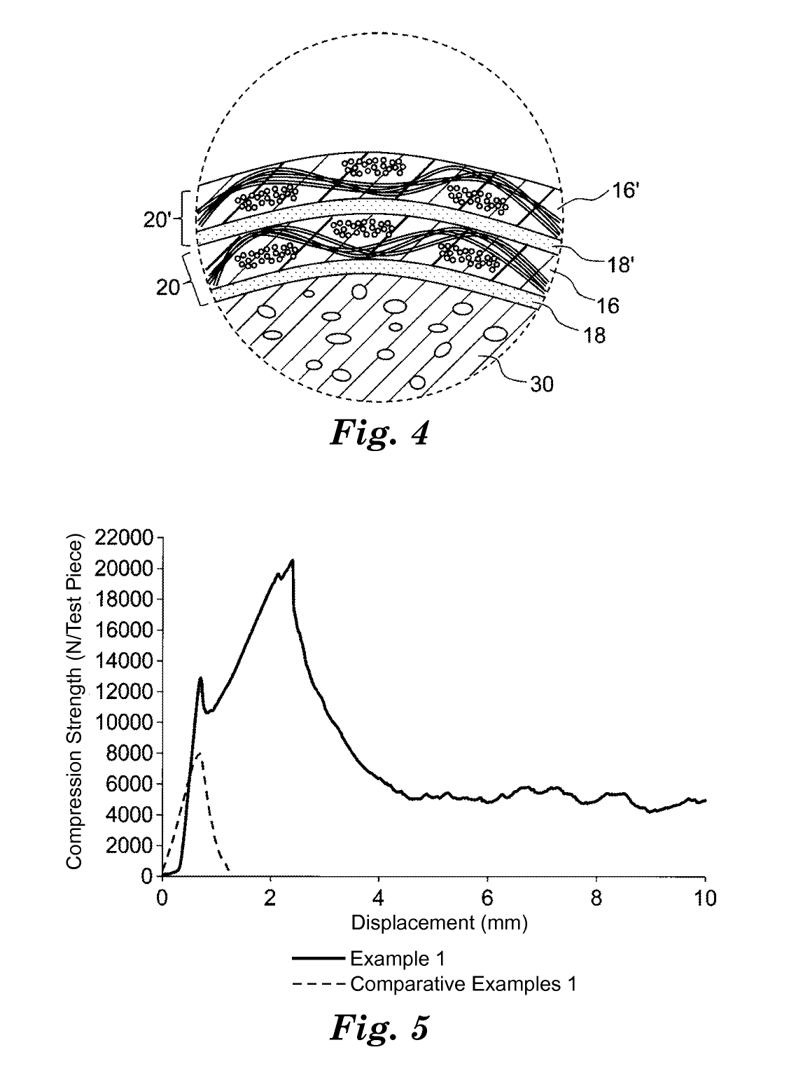

The reinforcement of a concrete pillar will be described with reference to FIGS. 2 to 4 as an example of using the building material-reinforcing repair tape. FIG. 2 is a perspective view of a concrete pillar 30 reinforced by wrapping a reinforcing repair tape 20. FIG. 3 is a cross-sectional view of the concrete pillar 30 with the reinforcing repair tape 20 wrapped twice therearound (the first wrapping being labeled 20 and the second wrapping being labeled 20′), and FIG. 4 is a magnified view of the part indicated by dotted lines in FIG. 3.

The surface is prepared by grinding the surface of the concrete pillar 30, the reinforcing repair tape 20 is disposed so that the layer of basic adhesive 18 faces the concrete pillar 30, and the reinforcing repair tape 20 is wrapped around the circumference of the concrete pillar 30, while tension is evenly applied thereto. Disposing the basic adhesive layer so as to face the concrete pillar allows for the prevention of reductions in strength due to neutralization of the surface of the concrete.

Reinforcing/repairing effects can be obtained via a single wrapping, but the tape may also be wrapped two or more times, as shown in FIGS. 3 and 4. Wrapping the reinforcing repair tape two or more times yields a constricting effect due to the tension upon the reinforcing repair tape 20. Here, “constricting effect” refers to an improvement in the strength, especially the compressive strength, of the reinforced building material or other adherend in a direction orthogonal to the direction in which the reinforcing repair tape is tightened (i.e., the direction in which tension is applied) due to the circumference of the adherend being bound by the reinforcing repair tape. In order to obtain a greater constricting effect, it is preferable that the lengthwise direction of the reinforcing fibers (for example, the warp fibers or filling fibers) be disposed in parallel to the tightening direction.

In addition, wrapping the reinforcing repair tape two or more times, as shown in FIG. 4, leads to contact between the acidic resin 16 of the first wrap and the basic adhesive 18′ of the second wrap. As a result, the acid-base interaction of the acidic resin 16 and the basic adhesive 18′ strengthens the bond between the first wrap and the second wrap, heightening integrity between the first and second wraps, and further improving shear strength in a direction parallel to the surface of the reinforcing repair tape. Thus, in accordance with the present disclosure, a building material such as a concrete pillar or a bridge pier can be imparted with the desired degree of compressive strength by wrapping the reinforcing repair tape multiple times around the building material, under tension.

The present invention is capable of reinforcing a building material, such as a concrete pillar or bridge pier, in isolation, or it can also be used for reinforcement in combination with existing methods such adhesive impregnation, sheet steel lining, frame reinforcement via reinforced concrete, or the like.

### Example

In the following examples, specific embodiments of the present disclosure are exemplified, but the present invention is not restricted thereto. All parts and percentages are by mass unless otherwise indicated.

The materials used in these examples are shown below in Table 1.

TABLE 1

| Trade name or | | |
|---|---|---|
| abbreviation | Description | Supplier |
| 2EHA | 2-ethylhexyl acrylate | Nippon Shokubai Co., Ltd. |
| AA | Acrylic acid | Toagosei Co., Ltd. |
| HDDA | 1,6-hexanediol diacrylate | Kyoeisha Chemical Co., |
| | | Ltd. |
| IOA | Isooctyl acrylate | 3M Company |
| DMAA | N,N-dimethylacrylamide | Kohjin |
| Irgacure 651 | Photopolymerization initiator | BASF (former Ciba |
| | 2,2-dimethoxy-2-phenylacetophenone | Specialty Chemicals) |
| 3M 3779 | Scotch-Weld ™ hot-melt adhesive | 3M Company |
| | Polyamide-based | |
| Haritac F85 | Stabilized rosin ester tackifier | Harima Chemicals |
| | | Group, Inc. |
| Torayca ® cloth | Carbon fibers, plain weave | Toray Industries, Inc. |
| CO6343 | Thickness 250 μm, mass 198 g/m² | |
| | Tensile strength 1.80 kN/mm² | |
| | Breaking elongation 2% | |
| Fibrasheet AK10/10 | Aramid fibers, bidirectional knitted | Fibex Co., Ltd. |
| | sheet | |
| | Thickness 480 μm, mass 180 g/m² | |
| | Tensile strength 2.10 kN/mm² | |
| | Breaking elongation 4% | |
| KTV 7446Y | Vinylon fibers, triaxial fabric | Nitto Boseki Co., Ltd. |
| | Thickness 360 μm, mass 42 g/m² | |
| | Tensile strength 0.02 kN/mm² | |
| | Breaking elongation 5% | |
| KS 2810 | Glass fibers, plain weave | Nitto Boseki Co., Ltd. |
| | Thickness 360 μm, mass 395 g/m² | |
| | Tensile strength 0.16 kN/mm² | |
| | Breaking elongation 5% | |

### <Test Methods>

### (1) Glass Transition Temperature

Glass transition temperature was measured via differential scanning calorimetry (DSC Q2000, TA Instruments). About from 5 to 15 mg of a sample was placed within a dedicated aluminum vessel, and differential scanning calorimetry was performed in an inert gaseous atmosphere over a temperature range from −100° C. to 150° C. at a temperature increase rate of 10° C./minute. Measurement was performed twice in a row, and the glass transition temperature was determined from the results of the second measurement.

### (2) Compression Test

A 25 mm-diameter, 50 mm-height cylindrical test concrete pillar was prepared using mortar (premix mortar M130, Yoko Bussan). Specifically, 100 parts by mass of M130 and 15.6 parts by mass of water were quickly mixed, and the mixed mortar was poured into a cylindrical mold. Next, the mortar was cured for 72 hours at a temperature of 25° C. and a relative humidity of 90%. After curing, the concrete pillar was removed from the mold, the surface of the mortar was washed with water, and the concrete pillar was thoroughly dried. An adhesive sheet cut to a width of 50 mm was wrapped twice around the obtained concrete pillar under tension so that the basic adhesive layer thereof faced the concrete pillar, after which the whole was cured for three days at 23±1° C. to create a test piece.

The obtained test piece was sandwiched between two 15 cm-diameter, 2 cm-thickness steel plates, placed in a tensilon tester (RTC-1325A; Orientec Co., Ltd.), and compressed in the height direction at a temperature of 25±3° C. at a compression speed of 1 mm/minute to measure compression strength (N/test piece). Values were obtained for the maximum value for compression strength and for the average value for compression strength (average compression strength) after a further 5 mm of compression was reached from the displacement value when the maximum value was reached.

<Preparing Reinforcing Fiber Sheet (Substrate Layer) Impregnated with Acidic Resin AR1>

70 parts by mass of 2-ethylhexyl acrylate (2EHA), 30 parts by mass of acrylic acid (AA), 0.14 parts by mass of Irgacure 651, and 1.0 parts by mass of 1,6-hexanediol diacrylate (HDDA) were introduced simultaneously into a planetary mixer and kneaded under reduced pressure (50 mmHg) for 15 minutes to obtain a polymerizable acrylic resin composition. The polymerizable acrylic resin composition is pre-polymerized acrylic resin composition.

The obtained polymerizable acrylic resin composition and one type of reinforcing fiber sheet selected from Torayca® cloth CO6343 (carbon fibers), Fibrasheet AK 10/10 (aramid fibers), KTV 7446Y (vinylon fibers), or KS 2810 (glass fibers) were sandwiched between two sheets of silicone-treated PET film and impregnated and calender-molded into a sheet shape.

The molded piece was further retained inside the two sheets of silicone-treated PET film, and both sides of the sheet were irradiated with UV radiation for two minutes apiece at an irradiation intensity of 0.3 mW/cm², and then for two minutes at an irradiation intensity of 6.0 mW/cm² to cure the composition, thus preparing an acidic resin AR1-impregnated reinforcing fiber sheet (substrate layer). Reinforcing fiber sheets impregnated with acidic resins AR2 through AR5 were similarly prepared, using Torayca® cloth CO6343 as the reinforcing fibers, in a manner similar to that of the acidic resin AR1-impregnated reinforcing fiber sheet, except that the composition of the acidic resins were as shown in table 2. A specimen for measuring the glass transition temperature of the acidic resin was prepared using a part of the completed reinforcing fiber sheet.

TABLE 2
Acidic resin (AR) compositions

| Acidic resin (AR) | 2EHA | AA | Irgacure 651 | HDDA |
|---|---|---|---|---|
| AR1 | 70 | 30 | 0.14 | 1.0 |
| AR2 | 70 | 30 | 0.14 | 0.08 |
| AR3 | 80 | 20 | 0.14 | 0.08 |
| AR4 | 90 | 10 | 0.14 | 0.08 |
| AR5 | 100 | 0 | 0.14 | 0.08 |

### <Preparing Basic Adhesive Layer BA1>

67.5 parts by mass of isooctyl acrylate (IOA), 2.5 parts by mass of AA, 0.14 parts by mass of Irgacure 651, 0.08 parts by mass of HDDA, and 30 parts by mass of N,N-dimethyl acrylamide (DMAA) were introduced simultaneously into a planetary mixer and kneaded for 15 minutes under reduced pressure (50 mmHg) to obtain a polymerizable acrylic resin composition. The polymerizable acrylic resin composition is pre-polymerized acrylic resin composition.

The obtained polymerizable acrylic resin composition was sandwiched between two sheets of silicone-treated PET film to yield a total thickness of 0.05 mm, and calender-molded into a sheet shape.

The molded piece was further retained inside the two sheets of silicone-treated PET film, and both sides of the sheet were irradiated with UV radiation for two minutes apiece at an irradiation intensity of 0.6 mW/cm², and then for two minutes at an irradiation intensity of 6.0 mW/cm² to cure the composition, after which one sheet of silicone-treated PET film was removed to prepare a basic adhesive layer upon a silicone-treated PET film carrier. A specimen for measuring the glass transition temperature of the basic adhesive was prepared by removing the silicone-treated PET film and cutting a part of the completed basic adhesive sheet.

### <Preparing Basic Adhesive Layer BA2 (Hot-Melt Adhesive Layer)>

A polyamide resin for hot-melt adhesives (3779, 3M Company) was cut into a small strip using a cutter knife, and the small polyamide strip was placed upon a 90 μm-thick paper liner having a release-treated surface. Some 0.05 mm iron spacers were placed around the small polyamide strip upon the paper liner, and a paper liner having a release-treated surface was placed upon the small polyamide strip and the iron spacers, sandwiching the polyamide resin and the iron spacer therebetween.

The laminate was heat-pressed at 180° C. for 30 seconds using a heater plate press device (N5042; NPa System Co., Ltd.), after which one release-treated paper liner was removed to obtain a 0.05 mm-thick hot-melt basic adhesive layer. A specimen for measuring the glass transition temperature of the hot-melt basic adhesive was prepared by removing the paper liner and cutting a part of the completed basic adhesive sheet.

### <Preparing Basic Adhesive Layer BA3 (Solvent-Based Adhesive Layer)>

100 parts by mass of a 1:1 mixed solvent of toluene and isopropyl alcohol were introduced into a lidded glass vessel, and 25 parts by mass of a polyamide resin for hot-melt adhesives (3779, 3M Company) and 15 parts by mass of a rosin ester tackifier (Haritac F85; Harima Chemicals Group) were added thereto. After thoroughly stoppering the vessel, heating was performed in a 65° C. oven for 12 hours to obtain a liquid polyamide dispersion.

The liquid dispersion was applied to a 0.09 mm-thick paper liner having a release-treated surface to obtain a solvent-based basic adhesive layer having a post-drying (65° C. oven for 3 minutes and 100° C. oven for 3 minutes) thickness of the adhesive layer of 0.05 mm. A specimen for measuring the glass transition temperature of the solvent-based basic adhesive was prepared by removing the paper liner and cutting a part of the completed basic adhesive sheet.

### <Preparing Adhesive Sheet>

The acidic resin-impregnated reinforcing fiber sheet and the basic adhesive layer were layered and cured at 23±1° C. for at least three days to prepare an adhesive sheet. The results of a compression test performed upon the obtained adhesive sheet and the results of a compression test performed upon a concrete pillar to which no adhesive sheet was applied constituting a comparative example 1 are shown. Adhesive sheets comprising basic adhesive layers BA2 and BA3 were applied to a concrete pillar while being heated by a dryer. The glass transition temperatures (Tg) of the acidic resins AR1 to 5 and the basic adhesive layers BA1 to 3 are presented together in table 3. A chart for the compression test performed on example 1 and comparative example 1 is shown in FIG. 5.

TABLE 3

| | | | | | | | | | Compression test | |
|---|---|---|---|---|---|---|---|---|---|---|
| | | | | | | | | | (kN/test piece) | |
| | Substrate layer | | | Basic adhesive | | Thickness (mm) | | | | Average |
| | Acidic resin (AR) | | Reinforcing | layer (BA) | | Substrate | | Adhesive | Maximum | compression |
| | Type | Tg (° C.) | fibers | Type | Tg (° C.) | layer | BA | sheet | value | strength |
| Example 1 | AR1 | 21 | CO6343 | BA1 | −7 | 0.35 | 0.05 | 0.40 | 21.0 | 7.0 |
| Example 2 | | | | BA2 | −5 | 0.35 | 0.05 | 0.40 | 17.2 | 9.4 |
| Example 3 | | | | BA3 | 16 | 0.35 | 0.05 | 0.40 | 16.0 | 7.3 |
| Example 4 | | | AK10/10 | BA1 | −7 | 0.58 | 0.05 | 0.63 | 18.6 | 13.1 |
| Example 5 | | | KTV 7446Y | | | 0.47 | 0.05 | 0.52 | 8.2 | 4.5 |
| Example 6 | | | KS 2810 | | | 0.46 | 0.05 | 0.51 | 13.2 | 10.7 |
| Example 7 | AR2 | 15 | CO6343 | | | 0.35 | 0.05 | 0.40 | 18.0 | 7.0 |
| Example 8 | AR3 | −20 | | | | 0.35 | 0.05 | 0.40 | 12.8 | 9.1 |
| Example 9 | AR4 | −51 | | | | 0.35 | 0.05 | 0.40 | 11.1 | 7.8 |
| Example 10 | AR5 | −71 | | | | 0.35 | 0.05 | 0.40 | 10.5 | 2.9 |
| Comparative | — | — | — | — | — | — | — | — | 7.7 | — |
| example 1 | | | | | | | | | | |

### REFERENCE NUMERALS

10 Adhesive sheet
12 Substrate layer
14 Reinforcing fibers
16, 16′ Acidic resin
18, 18′ Basic adhesive
20, 20′ Reinforcing repair tape
30 Concrete pillar

1. An adhesive sheet comprising a substrate layer comprising reinforcing fibers impregnated with an acidic resin and a basic adhesive layer disposed upon the substrate layer.

2. The adhesive sheet according to claim 1, wherein the acidic resin has a Tg of −60° C. or higher.

3. The adhesive sheet according to claim 1, wherein the basic adhesive layer comprises a pressure-sensitive adhesive or a hot-melt adhesive.

4. The adhesive sheet according to any one of claim 1, wherein the reinforcing fibers have a tensile strength of 0.01 kN/mm² or more and a breaking elongation of 10% or less as measured according to JIS A 1191:2004.

5. A reinforcing repair tape comprising the adhesive sheet described in any one of claim 1.

6. A building material-reinforcing repair tape comprising the adhesive sheet described in any one of claim 1.

7. A reinforced building material around which the building material-reinforcing repair tape described in claim 6 is wrapped.

8. The reinforced building material according to claim 7, around which the building material-reinforcing repair tape is wrapped two or more times.

9. A method of manufacturing a reinforced building material, the method comprising a step of wrapping the building material-reinforcing repair tape described in claim 6 around the circumference of a building material, under tension.
